(19) United States
(12) Patent Application Publication
(10) Pub. No.: US 2012/0246454 A1
(43) Pub. Date: Sep. 27, 2012

(54) ELECTRONIC DEVICE AND METHOD FOR CONTROLLING TEST PROCESS

(75) Inventor: YI-YONG XIE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/270,232

(22) Filed: Oct. 11, 2011

(30) Foreign Application Priority Data
Mar. 25, 2011 (CN) 201110073451.4

(51) Int. Cl. G06F 15/177

(52) U.S. Cl. 713/2

(57) ABSTRACT

In a method controls a test process of an electronic device, a booting mode of a test program is set as a non-preemptible mode. The method invokes system service programs from a storage device of the electronic device upon the condition that an operating system (OS) of the electronic device is booted. The method further boots a user-defined service program, loads the test program to test a target object of the electronic device using the user-defined service program, then boots system application programs and user application programs of the electronic device.

### BACKGROUND

1. Technical Field

Embodiments of the present disclosure relate to measurement technology, and particularly to an electronic device and method for controlling a test process of the electronic device.

2. Description of Related Art

Measurement is an important phase in manufacturing and is closely related to product quality. In recent years, test programs have been used to test target objects automatically. However, in an operating system of a test computer, a priority of a system service program is higher than that of a system application program, and the priority of the system application program is higher than that of a user application program. Because the test program belongs to a user application program, the system service programs and the system application programs need to be loaded first before the test program is run in the test computer. That is to say, the test program cannot work until the system service programs and the system application programs are loaded, thus a test time is increased. Therefore, a more efficient method for controlling a test process of an electronic device is desired.

### BRIEF DESCRIPTION OF THE DRAWINGS

FIG. 1 is a block diagram of one embodiment of an electronic device including a test management system.

FIG. 2 is a block diagram of function modules of the test management system included in the electronic device of FIG. 1.

FIG. 3 is a flowchart of one embodiment of a method for controlling a test process of the electronic device of the FIG. 1.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

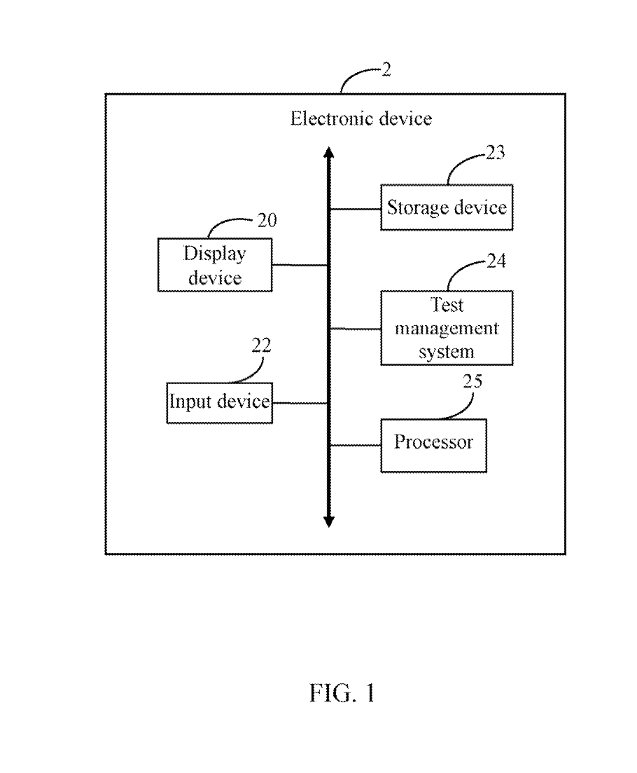

FIG. 1 is a block diagram of one embodiment of an electronic device 2 including a test management system 24. In the embodiment, the electronic device 2 further includes a display device 20, an input device 22, a storage device 23, and at least one processor 25. The electronic device 2 may be a computer, a server, or any computing device. The test management system 24 is used to improve a priority of a test program of the electronic device 2, and load the test program to be executed by the at least one processor 25 in advance. A detailed description will be given in the following paragraphs.

The display device 20 is used to display test results of a target object to be tested of the electronic device 2, and the input device 22 may be a mouse or a keyboard used to input computer readable data. In one embodiment, the target object may be a memory, a CPU, a video card, an audio card or other PCI devices of the electronic device 2.

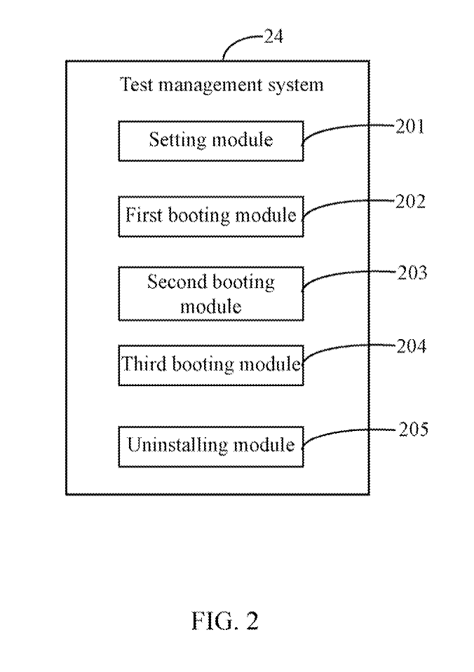

FIG. 2 is a block diagram of function modules of the test management system 24 included in the electronic device 2. In one embodiment, the test management system 24 may include one or more modules, for example, a setting module 201, a first booting module 202, a second booting module 203, a third booting module 204, and a uninstalling module 205. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives. The one or more modules 201-205 may comprise computerized code in the form of one or more programs that are stored in the storage device 23 (or memory). The computerized code includes instructions that are executed by the at least one processor 25 to provide functions for the one or more modules 201-205.

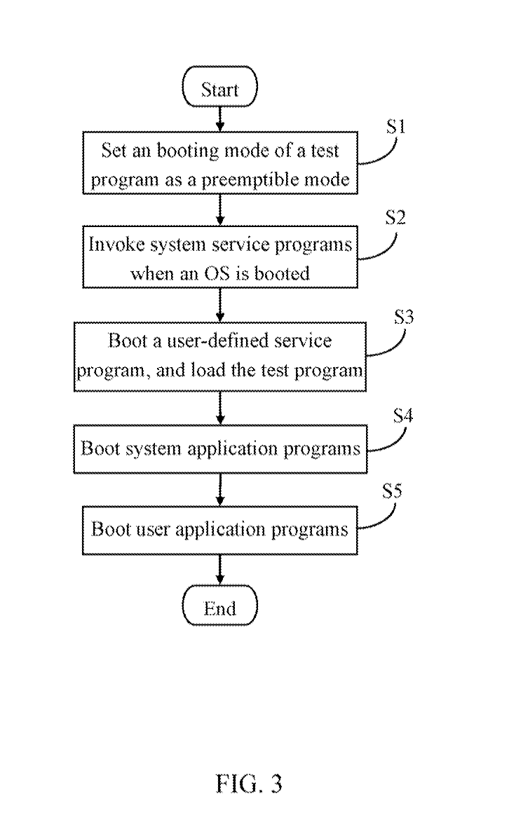

FIG. 3 is a flowchart of one embodiment of a method for controlling a test process using the electronic device 2. Depending on the embodiment, additional blocks may be added, others removed, and the ordering of the blocks may be changed.

In block S1, a user sets a booting mode of a test program as a preemptible mode having a higher priority than a system application program of the electronic device 2. In one embodiment, preemptible mode is used to change a booting sequence of the test program. For example, the test program is installed in a user-defined service program, a priority of the user-defined service program is lower than a priority of a system service program, but is higher than a priority of a system application program. If the preemptible mode is selected, the test program is loaded to be executed by the at least one processor 25 before the system application program.

In block S2, the first booting module 202 invokes the system service programs from the storage device 23 when an operating system (OS) of the electronic device 2 is booted. For example, the system service program is a domain name system (DNS) installed in the electronic device 2.

In block S3, the first booting module 202 boots the user-defined service program, and loads the test program to test a target object of the electronic device 2 using the user-defined service program.

In block S4, the second booting module 203 boots the system application programs of the electronic device 2. For example, the system application programs include a network connection program, a timer program, and an alarm program in the OS of the electronic device 2.

In block S5, the third booting module 204 boots user application programs of the electronic device 2. For example, the user application program may be a web page browsing tool (e.g., IE 6.0) in the electronic device 2.

Because the test program is installed in the user-defined service program, the test program has the same priority as the user-defined service program. Thus, the test program is loaded before the system application programs and the user-defined application programs are loaded. That is to say, the test program starts to work as soon as the system service programs are booted, thus, a test speed of the target object is improved.

In other embodiments, the user may change the booting mode of the test program to a non-preemptible mode. If the non-preemptible mode is selected, the test program is loaded finally. That is to say, if the booting mode is changed to the non-preemptible mode, the system service programs are booted first, the system application programs are booted second, then the test program and the user application programs are booted finally. If the test is complete, an uninstall program is invoked from a preset dynamic link library (DLL) of the storage device 23, so as to close the service of the user-defined service program using the uninstall program. If the booting mode is changed back to the preemptible mode, the user-defined service program is rebooted to boot the test program in advance.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for controlling a test process of an electronic device, the method comprising:
setting a booting mode of a test program, the booting mode comprising a preemptible mode or a non-preemptible mode;
invoking system service programs from a storage device of the electronic device upon the condition that an operating system (OS) of the electronic device is booted;
booting a user-defined service program upon the condition that the booting mode is the preemptible mode, and loading the test program to test a target object of the electronic device using the user-defined service program;
booting system application programs of the electronic device; and
booting user application programs of the electronic device.

2. The method according to claim 1, further comprising:
booting the system application programs after the system service programs are booted upon the condition that the booting mode is changed to the non-preemptible mode; and
booting the test program and the user application programs.

3. The method according to claim 2, further comprising:
invoking an uninstall program from a preset dynamic link library of the storage device upon the condition that the test is complete; and
closing service of the user-defined service program using the uninstall program.

4. The method according to claim 3, further comprising:
rebooting the user-defined service program upon the condition that the booting mode is changed back to the preemptible mode.

5. An electronic device, comprising:
a storage device;
at least one processor; and
one or more modules that are stored in the storage device and are executed by the at least one processor, the one or more modules comprising instructions:
to set a booting mode of a test program, the booting mode comprising a preemptible mode or a non-preemptible mode;
to invoke system service programs from the storage device upon the condition that an operating system (OS) of the electronic device is booted;
to boot a user-defined service program upon the condition that the booting mode is the preemptible mode, and load the test program to test a target object of the electronic device using the user-defined service program;
to boot system application programs of the electronic device; and
to boot user application programs of the electronic device.

6. The electronic device according to claim 5, wherein the one or more modules further comprise instructions:
to boot the system application programs after the system service programs are booted upon the condition that the booting mode is changed to the non-preemptible mode; and
to boot the test program and the user application programs.

7. The electronic device according to claim 6, wherein the one or more modules further comprise instructions:
to invoke an uninstall program from a preset dynamic link library of the storage device upon the condition that the test is complete; and
to close service of the user-defined service program using the uninstall program.

8. The electronic device according to claim 7, wherein the one or more modules further comprise instructions:
to reboot the user-defined service program upon the condition that the booting mode is changed back to the preemptible mode.

9. A non-transitory storage medium having stored thereon instructions that, when executed by a processor of an electronic device, causes the electronic device to perform a method for controlling a test process, the method comprising:
setting a booting mode of a test program, the booting mode comprising a preemptible mode or a non-preemptible mode;
invoking system service programs from a storage device of the electronic device upon the condition that an operating system (OS) of the electronic device is booted;
booting a user-defined service program upon the condition that the booting mode is the preemptible mode, and loading the test program to test a target object of the electronic device using the user-defined service program;
booting system application programs of the electronic device; and
booting user application programs of the electronic device.

10. The non-transitory storage medium according to claim 9, wherein the method further comprises steps of:
booting the system application programs after the system service programs are booted upon the condition that the booting mode is changed to the non-preemptible mode; and
booting the test program and the user application programs.

11. The non-transitory storage medium according to claim 10, wherein the method further comprises steps of:
invoking an uninstall program from a preset dynamic link library of the storage device upon the condition that the test is complete; and
closing service of the user-defined service program using the uninstall program.

12. The non-transitory storage medium according to claim 11, wherein the method further comprises a step of:
rebooting the user-defined service program upon the condition that the booting mode is changed back to the preemptible mode.

13. The non-transitory storage medium according to claim 9, wherein the medium is selected from the group consisting of a hard disk drive, a compact disc, a digital video disc, and a tape drive.
